(19) United States
(12) Patent Application Publication
(10) Pub. No.: US 2015/0143753 A1
(43) Pub. Date: May 28, 2015

(54) STRUCTURE OF BODY SIDE WEATHER STRIP

(71) Applicants: Hyundai Motor Company, Seoul (KR); Kia Motors Corporation, Seoul (KR)

(72) Inventor: Jeong-Hyeon KIM, Seoul (KR)

(73) Assignees: Hyundai Motor Company, Seoul (KR); Kia Motors Corporation, Seoul (KR)

(21) Appl. No.: 14/505,709

(22) Filed: Oct. 3, 2014

(30) Foreign Application Priority Data
Nov. 25, 2013 (KR) 10-2013-143439

(51) Int. Cl. B60J 10/00; B62D 65/08

(52) U.S. Cl. CPC B60J 10/0031; B60J 10/0002; B60J 10/0054; B60J 10/0088
USPC 49/498.1

(57) ABSTRACT

A structure of a body side weather strip may include a carrier fixed to a door frame disposed around a door opening of a vehicle body, a first folding portion protruding upward from a top of the carrier and bending substantially horizontally, and a cylindrical tube fixed to an end of the first folding portion and the top of the carrier and having a space. When an external force is applied to the tube, the first folding portion may turn about a first rotation shaft such that a bottom of the first folding portion and the top of the carrier may come in surface contact with each other.

### CROSS-REFERENCE TO RELATED APPLICATIONS

The present application claims priority of Korean Patent Application Number 10-2013-143439 filed on Nov. 25, 2013, the entire contents of which application is incorporated herein for all purposes by this reference.

### BACKGROUND OF INVENTION

1. Field of Invention

The present invention relates to a structure of a body side weather strip which is disposed around a door opening of a vehicle body, and more particularly, to a structure of a body side weather strip which has a first folding portion protruding upward from the top of a carrier and bending horizontally or substantially horizontally and a second folding portion formed at one end of a tube and minimizes stress and deformation of the tube shape by folding in two stages when external force is applied.

2. Description of Related Art

A weather strip, which is a part disposed around a fixed glass such as the front rear glasses and the quarter glass of a vehicle or the parts that is opened/closed such as the doors and the sunroof of a vehicle, preventing raindrops or dust from flowing into a vehicle, and blocking noise and vibration from the outside, is generally made of an elastic rubber material to be long and thin.

There are front and rear glass weather strips, a body side weather strip, and a glass-integrated weather strip and they are attached to different portions, but they generally require sufficient airtightness and high waterproofness, weatherability, and abrasion resistance.

The body side weather strips that are disposed around the doors at both sides of a vehicle prevent a side of doors from coming in direct contact with the vehicle body when opening and closing, and prevent foreign substances from flowing inside through the gaps between the doors and the vehicle body. The shape, the mounting position, and the mounting type of the body side weather strips are determined in consideration of movement of doors, the cross-sectional shapes between a vehicle body and doors, and the influence by doors in driving.

As illustrated in FIG. 1, a body side weather strip is formed to be long and thin and fitted in a door frame 2 around a door opening 1 of a vehicle body in the shape of a ring. As illustrated in FIG. 2, a body side weather strip of the related art is composed of a carrier 3 fixed to a door frame 2 of a vehicle body, a neck 4 protruding from the top of the carrier 3, and a hollow tube 5 connected to the top of the neck 4.

However, the structure of the body side weather strip of the related art has a problem in that the tube of the body side weather strip is too much deformed by the hip of a passenger getting into/out of the vehicle and accordingly, the body side weather strip is damaged, for example, cracks on the surface of the tube or breakage of the protective coating layer over the tensile strength of the tube.

The surface of the tube is scratched by friction between the tube surface and the hip of a passenger getting into/out of the vehicle or between the tube and the carrier, such that the protective coating layer of the tube is damaged and the tube is worn. In particular, for heavy passengers, at the backseats with relatively small door openings of a vehicle body, and in taxes that passengers frequently get in/off, the body weather strips are frequently damaged.

Since longitudinal wear of body side weather strips are tested in the current abrasion resistance test of a body side weather strip, it does not actually consider the interference of body side weather strips that are moved up/down, forward, and inside in a vehicle by the passenger's hip.

According to an abrasion resistance test in which a friction member is rubbed at 45° against a cross-section of a body side weather strop in consideration of the actual field conditions, there is a problem in that the body side weather strips of the related art fail to satisfy the friction standard (e.g., no damage under 2,000 times).

The information disclosed in this Background section is only for enhancement of understanding of the general background of the invention and should not be taken as an acknowledgement or any form of suggestion that this information forms the prior art already known to a person skilled in the art.

SUMMARY OF INVENTION

The present invention has been made in an effort to provide a body side weather strip that minimizes deformation of a body side weather strip tube due to the hip of a passenger, minimizes stress in the tube, and satisfies the friction standard of a new abrasion resistance test of a body side weather strip.

Various aspects of the present invention provide a structure of a body side weather strip including: a carrier fixed to a door frame disposed around a door opening of a vehicle body; a first folding portion protruding upward from a top of the carrier and bending substantially horizontally; and a cylindrical tube fixed to an end of the first folding portion and the top of the carrier and having a space therein, wherein when an external force is applied to the tube, the first folding portion turns about a first rotation shaft such that a bottom of the first folding portion and the top of the carrier come in surface contact with each other.

The bottom of the first folding portion may be formed in a shape substantially the same as that of the top of the carrier.

A second folding portion may be formed at one end of the tube which is connected with the end of the first folding portion, and the second folding portion may be turned about a second rotational shaft toward the first folding portion by the external force applied on the tube such that an inner side of the second folding portion may come in surface contact with a top of the first folding portion.

The inner side of the second folding portion may be formed in a shape substantially the same as that of the top of the first folding portion. The second rotational shaft may be formed in a shape of an arc with a radius of 0.3 mm to 0.9 mm.

The end of the first folding portion may be disposed at a predetermined distance inward from a side of the carrier, such that a gap is formed between the end of the first folding portion and the side of the carrier. The gap between the end of the first folding portion and the side of the carrier may be 0.5 mm to 2 mm.

The first folding portion may be made of an EPDM solid to prevent damage to the first folding portion.

According to the present invention, sine the structure of a body side weather strip has a two-stage folding structure including the first folding portion and/or the second folding portion, excessive deformation of the tube due to the hip of a passenger getting into a vehicle is prevented such that the surface of the tube is not deformed over the tensile strength, and deformation of the body side weather strip is minimized.

When external force is applied to the tube of the body side weather strip, the first folding portion is brought in surface contact with the top of the carrier, with the bottom of the first folding portion and the top of the carrier in the same or substantially the same shape, such that the stress in the tube is distributed and prevented from concentrating on a specific portion.

Since the second folding portion turns toward the first folding portion with the inner side of the second folding portion and the top of the first folding portion in the same or substantially the same shape, when there is additional external force remaining even after the first contact portion comes in surface contact, the stress in the tube is distributed and excessive deformation and stress of the tube are prevented.

Since there is a step or a gap between the end of the first folding portion and the side of the carrier in the body side weather strip so that the hip of a passenger getting into a vehicle comes in contact with the carrier that is strong against damage, the body side weather strip is prevented from wearing with the contact with the tube minimized.

Unlike the entire tube of body side weather strips of the related art is made of an EPDM sponge, the first folding portion that comes in contact with the top of the carrier is made of an EPDM solid, such that the possibility of damage of the body side weather strip is minimized.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating door openings at a side of a common vehicle body.

FIG. 2 is a cross-sectional view of a structure of a body side weather strip of the related art.

FIG. 3 is a cross-sectional view of an exemplary structure of a body side weather strip according to the present invention.

FIG. 4 is an enlarged cross-sectional view of the portion A of FIG. 3.

FIG. 5 is an enlarged cross-sectional view illustrating a gap between the end of a first folding portion and a side of a carrier in an exemplary structure of a body side weather strip according to the present invention.

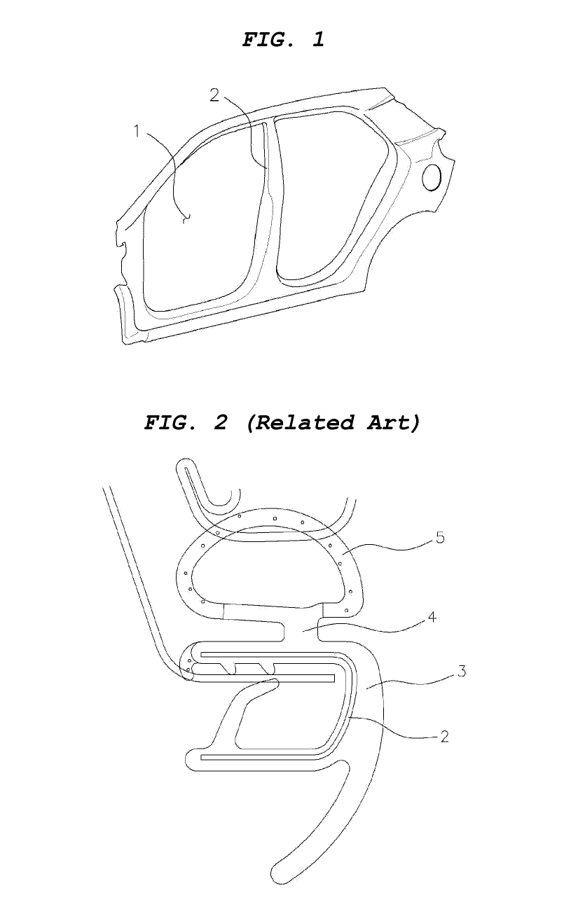

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A structure of a body side weather strip according to the present invention includes a carrier 20 fixed to a door frame 10 disposed around a door opening of a vehicle body, a first folding portion 30 protruding upward from the top 22 of the carrier and bending horizontally or substantially horizontally, and a cylindrical tube 40 fixed to the end of the first folding portion 30 and the top of the carrier 20 and having a space therein. When external force is applied to the tube 40, the first folding portion 30 turns about a first rotation shaft or portion 36 and the bottom 32 of the first folding portion and the top 22 of the carrier come in surface contact with each other.

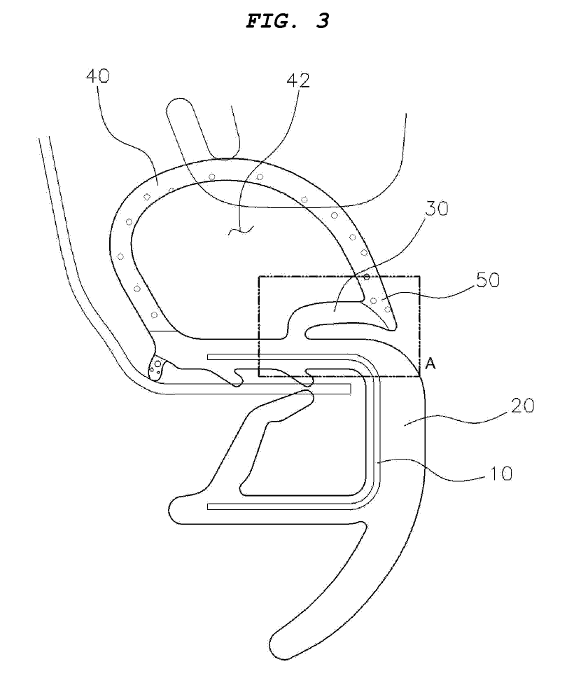

As illustrated in FIG. 3, the carrier 20 is inserted and fixed in the door frame 10 formed around the door opening of a vehicle body and the carrier 20 support the entire body side weather strip. The carrier 20 is made of solid type ethylene propylene diene monomer (hereafter, referred to as EPDM solid).

The EPDM solid, a thermoplastic synthetic rubber made by polymerizing ethylene and propylene, is used for various parts of a vehicle body such as an O-ring, a bumper, and a weather strip, because of high weatherability, ozone resistance, heat resistance, cold resistance, durability, and modulus of elongation etc. in comparison to common synthetic rubber (SBR, SBS, and NBR etc.).

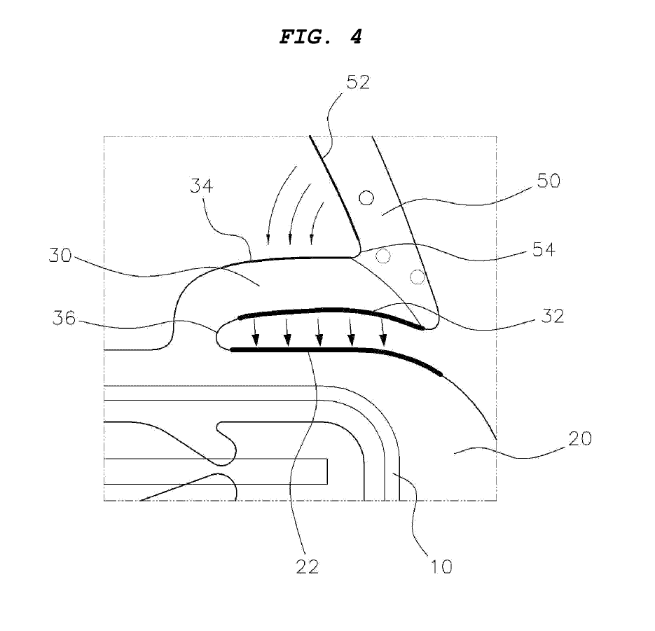

As illustrated in FIGS. 3 and 4, the first folding portion 30 protrudes from the top 22 of the carrier, in detail, the first folding portion 30 extends upward from the top 22 of the carrier and bends horizontally or substantially horizontally outward.

As illustrated in FIG. 4, the first folding portion 30 can turn toward the top 22 of the carrier about the first rotational shaft or portion 36 formed at the opening end of the first folding portion 30 and the first rotational shaft or portion 36 is formed in the shape of an arc recessed inward.

As illustrated in FIG. 3, the cylindrical tube 40 with an internal space 42 is connected to the tops of the carrier 20 and the first folding portion 30, having a circular or substantially circular cross-section between the end of the first folding portion 30 and the top of the carrier 20.

The tube 40 is made of an ethylene propylene diene monomer or the like (hereafter, referred to as an EPDM sponge) and the EPDM sponge is made in a sponge type by polymerizing ethylene and propylene.

As illustrated in FIG. 4, when external force is applied to the tube 40 by the hip of a passenger getting into the vehicle, the first folding portion 30 folds toward the carrier 20 about the first rotational shaft or portion 36, such that the stress in the body side weather strip is distributed and wear of the body side weather strip due to stress concentration can be prevented.

As illustrated in FIG. 4, it is preferable that the bottom 32 of the first folding portion and the top 22 of the carrier are formed in the same or substantially the same shape, and accordingly, when the first folding portion 30 is folded toward the carrier 20 by external force, the bottom 32 of the first folding portion and the top 22 of the carrier come in close contact with each other. This is for uniformly preventing the stress in the body side weather strip from concentrating on a specific portion through the surface contact structure of the carrier 20 and uniformly distributing it.

As illustrated in FIG. 4, in some embodiments, it is preferable that the end of the tube 40 which is in contact with the first folding portion 30 functions as a second folding portion 50 turning toward the first folding portion 30 about a second rotational shaft or portion 54.

The second folding portion 50 prevents deformation and excessive stress of the tube 40 by folding inward when external force remains, even after the first folding portion 30 is brought in close contact with the top 22 of the carrier.

That is, the body side weather strip of the present invention has a two-step folding structure in which the first folding portion 30 folds first toward the carrier 20 by external force applied to the sub 40, and then the second folding portion 50 folds toward the first folding portion 30 when there is additional external force remaining.

As illustrated in FIG. 4, the second rotational shaft or portion 54 is formed in the shape of an arc recessed on the inner side 52 at the joint of the first folding portion 30 and the second folding portion 50, and when there is addition external force remaining on the tube 40, it guides the second folding portion 50 folding toward the first folding portion 30.

In some embodiments, it is preferable that the radius of the second rotational shaft or portion 54 is 0.3 mm to 0.9 mm and in some embodiments, it is preferable that the radius is about 0.3 mm that is the minimum available for the structure of a body side weather strip.

As illustrated in FIG. 4, in some embodiments, it is preferable that the inner side 52 of the second folding portion is formed in the same or substantially the same shape as the top 34 of the first folding portion, and accordingly, when as the second folding portion 50 is folded toward the first folding portion 30 by external force, the inner side 52 of the second folding portion and the top 34 of the first folding portion comes in close contact with each other.

As described above, since the second folding portion 50 makes a surface contact structure with the first folding portion 30, the stress in the body side weather strip is not concentrated on a specific portion, but uniformly distributed in the entire body side weather strip.

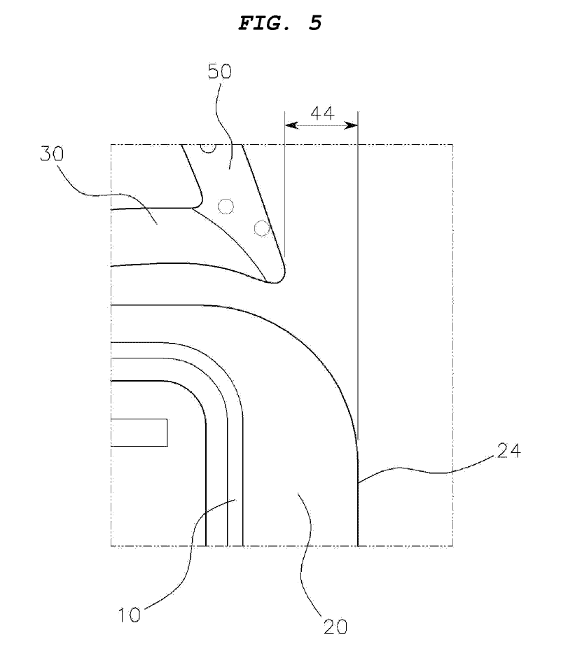

As illustrated in FIG. 5, in some embodiments, it is preferable that the end of the first folding portion 30 at the joint of the first folding portion 30 and the second folding portion 50 is recessed inward at a predetermined distance from the side 24 of the carrier.

That is, a predetermined gap is defined between the end of the first folding portion 30 and the side 24 of the carrier, such that the hip of a passenger getting into the vehicle comes in contact with the carrier 20 that is relatively strong, thereby minimizing the contact with the tube 40.

In some embodiments, it is preferable that the gap 44 between the end of the first folding portion 30 and the carrier 20 and in some embodiments, it is preferable that the gap 44 is about 2 mm that is the maximum available for keeping the sealing function of the body side weather strip.

As illustrated in FIG. 3, in some embodiments, it is preferable that the first folding portion 30 is made of an EPDM solid, and thus the possibility of damage of the first folding portion 30 is minimized.

As illustrated in FIG. 2, in the strip of a body side weather strip of the related art, only the carrier 3 and the neck 4 are made of an EPDM solid and the tube 5 on the neck 4 is made of an EPDM sponge, while in the structure of a body side weather strip according to the present invention, as illustrated in FIG. 3, even the first folding portion 30 forming the lower portion of the tube 40 is made of an EPDM solid.

Since the first folding portion 30, which is a part keeping in contact with the top 22 of the carrier when external force is applied to the tube 40, is made of an EPDM solid that is strong against damage, such that the possibility of damage of the entire body side weather strip is reduced.

The operation of the structure of a body side weather strip according to the present invention as follows.

As illustrated in FIG. 5, since the gap 44 is defined or formed between the end of the first folding portion 30 and the side 24 of the carrier, the hip of a passenger getting into the vehicle comes in contact with the carrier 20 first.

As illustrated in FIG. 4, when external force keeps applied to the body side weather strip, the first folding portion 30 first turns toward the carrier 20 and the bottom 32 of the first folding portion comes in close contact with the top 22 of the carrier, such that stress in the body side weather strip is distributed.

As illustrated in FIG. 4, when there is additional force remaining even after the first folding portion 30 is matched with the carrier 20, the second folding portion 50 turns toward the first folding portion 30 and the inner side 52 of the second folding portion comes in close contact with the top 34 of the first folding portion, such that deformation and stress of the tube are reduced.

For convenience in explanation and accurate definition in the appended claims, the terms “inner” or “outer”, “top” or “bottom”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure of a body side weather strip, comprising:
a carrier fixed to a door frame disposed around a door opening of a vehicle body;
a first folding portion protruding upward from a top of the carrier and bending substantially horizontally; and
a cylindrical tube fixed to an end of the first folding portion and the top of the carrier and having a space therein,
wherein when an external force is applied to the tube, the first folding portion turns about a first rotation shaft such that a bottom of the first folding portion and the top of the carrier come in surface contact with each other.

2. The structure of claim 1, wherein the bottom of the first folding portion is formed in a shape substantially the same as that of the top of the carrier.

3. The structure of claim 1, wherein:
a second folding portion is formed at one end of the tube which is connected with the end of the first folding portion, and
the second folding portion is turned about a second rotational shaft toward the first folding portion by the external force applied on the tube such that an inner side of the second folding portion comes in surface contact with a top of the first folding portion.

4. The structure of claim 3, wherein the inner side of the second folding portion is formed in a shape substantially the same as that of the top of the first folding portion.

5. The structure of claim 3, wherein the second rotational shaft is formed in a shape of an arc with a radius of 0.3 mm to 0.9 mm.

6. The structure of claim 1, wherein the end of the first folding portion is disposed at a predetermined distance inward from a side of the carrier, such that a gap is formed between the end of the first folding portion and the side of the carrier.

7. The structure of claim 6, wherein the gap between the end of the first folding portion and the side of the carrier is 0.5 mm to 2 mm.

8. The structure of claim 1, wherein the first folding portion is made of an EPDM solid to prevent damage to the first folding portion.
